(19) United States
(12) Patent Application Publication
(10) Pub. No.: US 2009/0286021 A1
(43) Pub. Date: Nov. 19, 2009

(54) Ink jet recording sheet useful as transfer substrate

(75) Inventors: Gregory Stephen Kulibert, Oshkosh, WI (US); Robert Stanley Bobnock, Menasha, WI (US)

Correspondence Address: APPLETON PAPERS INC.;LAW DEPARTMENT, 825 E. WISCONSIN AVENUE, PO BOX 359, APPLETON, WI, 54912-0359, US

(73) Assignee: Appleton Papers Inc., Appleton, WI (US)

(21) Appl. No.: 12/384,716

(22) Filed: Apr. 8, 2009

Related U.S. Application Data
(60) Provisional application No. 61/071,691, filed on May 13, 2008.

(51) Int. Cl. B41M 5/50

(52) U.S. Cl. 428/32.12

(57) ABSTRACT

The present invention relates to a thermal transfer image receiving sheet comprising a substrate sheet having a first surface and second surface; a non-separable transfer layer provided on at least a first surface of the substrate; optionally an intermediate layer is coated between the transfer layer and paper substrate. The non-separable transfer layer and optional intermediate layer are relatively permanently affixed to the substrate. The intermediate layer can comprise an oil absorptive pigment having an absorbance of at least 90 grams per square meter, and a binder composition comprising a water soluble carboxyalkyl starch or cellulose at from 0.1 to 25 percent by weight based on weight of the intermediate layer. The transfer layer comprises an oil absorptive pigment having an absorbance of at least 90 grams per square meter, and a binder composition comprising water soluble carboxyalkyl starch or carboxyalkyl cellulose at from 0.1 to 20 percent by weight based on weight of the transfer layer. The surface of the transfer image receiving sheet is fast drying to the touch.

This application under 35 USC §111(a) claims benefit per 35 USC §119(e) to application Ser. No. 61/071,691 filed May 13, 2008 as a provisional application 35 USC §111(b).

### BACKGROUND OF THE INVENTION

1. Field of Invention

The present invention relates to an ink jet recording sheet, more particularly an ink jet recording sheet useful as a transfer paper.

Ink jet transfer is a direct-indirect printing means for transferring images onto a variety of surfaces dye sublimation dyes. Sublimation is a process of phase change wherein a solid transitions from a solid to a gas state without transitioning a liquid phase.

In dye sublimation printing various dyes are directly onto a printing media and dried using an ink jet or bubble jet printer. The ink jet receiver sheet is then used to indirectly transfer the images to a variety of substrates and surfaces such as textiles, canvas, t-shirts, hats, tiles, metals, bricks, stoneware, glass, poster board, and the like.

The dye is selected to be compatible with the surface, or the surface with the sublimable dye. With textiles, the textile fabric is preferably selected to be compatible with the sublimable dye being transferred and typically selected from polyesters, polyester blends, cottons, silks, nylons, and other natural or synthetic fibers respective of the inks.

Ink jet transfer papers enable a common ink jet or bubble jet printer to be used to create a customized design on an ink jet recording sheet which is then used with a heat press to transfer the images to a textile or hard surface such as tile or other surface.

In ink jet recording, fine droplets of ink are jetted by an ink jet printer or bubble jet printer onto a recording sheet to form a recording of characters, letters or images. Ink jet printers have advanced and excel in characteristics of high speed, multi-color even photographic quality imaging, low noise, easiness of use.

A variety of coatings for paper and film substrates have been designed. For many commercial applications paper substrates are preferred since they are generally less expensive than polymeric or film substrates.

Ink jet recording sheets need to meet a variety of stringent requirements including:
1. Ability to feed through automated sheet feeders in common recording apparati.
2. Cockling or wrinkling of the imaged sheet is prevented.
3. The printed image is of high quality.
4. The printed dot density is high and image density is high.
5. The individual droplets are held such as to maintain discrete dot shapes.
6. The colors of the dots are acceptable and the images are sharp consistent with industry standards.
7. The storage properties of the ink jet recording sheet is acceptable in terms of image stability.
8. Background discoloration is minimal.
9. Fine printed images can be obtained without substantial bleeding at areas of superposed colors.

The present invention teaches a novel ink jet transfer image receiving sheet. Although ink jet transfer papers are known, they suffer drawbacks of cockling when inks are absorbed or held by the sheet.

To overcome some of the deficiencies in current ink jet transfer papers some manufacturers have speculated that limiting porosity is key to preventing cockle and have prepared either pigment free or barrier layers. The resultant papers with barrier coating, although reducing cockle or water absorption into the sheet however have the drawback of holding the ink close to the barrier surface layer. The resultant sheet displays protracted surface wetness and is slow to dry. The phenomenon can be thought of as similar to trying to write with a felt pen onto a plastic surface. The ink tends to be repelled or pools closer to the surface. The ink can smear and drying is prolonged. Many commercial papers suffer this drawback and it would be an advance in the art to overcome this aspect.

Drawbacks of known ink jet transfer sheets include problems related to transfer efficiency, susceptibility to curl, protracted surface wetness, susceptibility of the inks dispersed in aqueous solvent to smear or become contaminated during prolonged drying, and/or wet feel of the surface. Other drawbacks include sticking to the target surface when used in indirect printing.

Such residue can tarnish, disrupt the surface smoothness, create surface imperfections, or lead to visual defects in the appearance of a target surface onto which the image receiving sheet is being used for purposes of indirect printing onto the next surface.

### SUMMARY OF THE INVENTION

The present invention teaches a novel transfer paper and thermal transfer image receiving sheet. In one embodiment, the thermal transfer image receiving sheet comprises a substrate sheet having a first surface and second surface; a non-separable transfer layer provided on at least a first surface of the substrate; an intermediate layer coated between the transfer layer and paper substrate; wherein the non-separable transfer layer and intermediate layer are relatively permanently affixed to the substrate; wherein the intermediate layer comprises an oil absorptive pigment having an absorbance of at least 90 grams per square meter, and a binder composition comprising a water soluble carboxyalkyl starch or cellulose at from 0.1 to 25 percent by weight based on weight of the intermediate layer; wherein the transfer layer comprises an oil absorptive pigment having an absorbance of at least 90 grams per square meter, and a binder composition comprising water soluble carboxyalkyl starch or carboxyalkyl cellulose at from 0.1 to 20 percent by weight based on weight of the transfer layer. The thermal transfer image receiving sheet or transfer paper is overcoated with a transfer layer and has a surface drying time of less than 5 minutes at 28° C. and 55% relative humidity.

In a further embodiment, the thermal transfer image receiving sheet intermediate layer coat weight is at least 3 grams per square meter. Preferably the thermal transfer image receiving sheet is a transfer paper. Accordingly and preferably the substrate comprises a cellulose-based material. Desirably the binder is a carboxyalkyl starch or cellulose, and preferably is carboxymethyl starch or carboxymethyl cellulose.

In a yet further embodiment, transfer paper useful as a thermal transfer image receiving sheet comprises a substrate sheet having a first surface and second surface; one or more layers comprising a non-separable transfer layer provided on at least a first surface of the substrate; and an optional intermediate layer coated between the transfer layer and paper substrate. The non-separable transfer layer and intermediate layer are relatively permanently affixed to the substrate. The intermediate layer comprises from 3 to 70 weight percent of an oil absorptive pigment having an absorbance of at least 90 grams per square meter. A binder composition comprising a water soluble carboxyalkyl starch or cellulose at from 0.1 to 20 percent by weight based on weight of the intermediate layer is included in the intermediate layer. The transfer layer comprises from 3 to 70 weight percent of an oil absorptive pigment having an absorbance of at least 90 grams per square meter, and a binder composition comprising water soluble carboxyalkyl starch or cellulose at from 0.1 to 20 percent by weight based on weight of the transfer layer. The transfer paper or receiving sheet surface drying time is less than 4 min at 28° C. and 55% relative humidity. In a yet further embodiment, the transfer paper intermediate layer has a coat weight is at least 3 grams per square meter.

In an alternative embodiment the transfer paper useful as a thermal transfer image receiving sheet comprises a substrate sheet having a first surface and second surface; a non-separable transfer layer provided on at least a first surface of the substrate and forming a new surface; wherein the non-separable transfer layer is relatively permanently affixed to the substrate; wherein the transfer layer comprises an oil absorptive pigment having an absorbance of at least 90 grams per square meter, and a binder composition comprising water soluble carboxyalkyl starch or carboxyalkyl cellulose at from 0.1 to 20 percent by weight based on weight of the transfer layer; wherein the new surface of the transfer image receiving sheet is fast drying.

Desirably, the surface drying time of the transfer paper or thermal transfer image receiving sheet is less than 5 minutes at 28° C. and 55% relative humidity. The intermediate layer preferably has a coat weight of at least 3 grams per square meter and preferably the substrate comprises a cellulose-based material.

The ink jet transfer paper of the invention has remarkable fast drying surface characteristics and functions as a transfer paper to transfer high quality images onto other surfaces. The ink jet transfer paper of the invention has remarkable ability to rapidly yield a dry-to-the-touch surface compared to other transfer papers. A high quality image transfer sheet is taught which is usefully less prone to smearing or other imperfections.

### DETAILED DESCRIPTION OF THE INVENTION

The present invention teaches a novel thermal transfer image receiving sheet. The image receiving sheet can be paper or polymeric, and preferably paper or otherwise cellulose-based papers and films.

The substrate sheet has a first surface and second surface.

In one embodiment the thermal transfer image receiving sheet has provided on a surface of the sheet a plurality of at least two layers comprising at least a non-separable transfer layer and an intermediate layer between the transfer layer and the substrate.

Unlike barrier layers coated transfer papers, the coating on the ink jet thermal transfer receiving sheet is very absorptive of water-based sublimable dyes. This is accomplished by fashioning the non-separable transfer layer using a very absorptive filler. When water based ink is applied to the receiving sheet of the invention, it dries fast keeping the ink particles near the surface available for efficient transfer in the indirect printing process for which the receiving sheet is adapted to be used.

The intermediate layer is believed to delay the separating water phase from reaching the paper fibers of the substrate by absorbing the water phase.

By controlling composition of the transfer layer and the intermediate layer the invention uniquely enables delay in the water phase such that if cockle occurs, it would only occur after the print head. In this way print head strike is not impaired. Prior art processes focused on minimizing porosity or using high load CMC (carboxymethylcellulose) barriers introducing slow drying problems. The invention resolves drying while providing a superior ink jet transfer sheet.

In the alternative embodiment, the thermal transfer image receiving sheet has provided on the substrate a transfer layer comprising an oil absorptive pigment having an absorbance of at least 90 grams per square meter, and a binder composition comprising a water soluble carboxyalkyl starch or carboxyalkyl cellulose at from 0.1 to 20 percent by weight based on weight of the transfer layer.

The substrate is preferably paper. The transfer layer composition is fashioned such that its surface is rapidly drying. The surface drying time of the thermal image receiving sheet has a surface drying time of less than 5 minutes at 28° C. and 55% relative humidity. Drying times will vary typically being slower at higher humidities and lower temperatures. Drying times will typically be faster at higher temperatures and lower humidities.

The substrate sheet of the ink jet recording sheet is a substrate material which can be in sheet or roll form. For purposes of this invention, substrate sheet can be referred to as support member and is to be understood to mean webs, ribbons, rolls, tapes, belts, films, cards and the like. Substrate sheets typically denote articles having two large surface dimensions and a comparatively small thickness dimension. The substrate sheet material can be opaque, transparent or translucent and could, itself, be colored or not. The material can be fibrous including, for example, paper and filamentous synthetic materials. It can be a film including, for example, films and cellophane and synthetic polymeric sheet substrates cast, extruded, or otherwise formed. Preferably the substrate sheet material is paper or cellulose-based.

In manufacturing the ink jet recording sheet, the coating compositions for the transfer layer and intermediate layer are prepared by forming a fine dispersion of the component binder materials, fillers surfactants, oil absorptive pigment, Group IA or IIA alkoli or alkaline with metal carbonate, and other additives in an aqueous coating medium.

Preferably the substrate sheet material is from 20 to 120 pounds per 3300 square foot ream, more preferably 30 to 90 pounds, and most preferably from 50 to 90 pounds.

The transfer layer comprises from 10 to 60 weight percent of an oil absorptive pigment having an absorbance of at least 90 grams per square meter. The transfer layer comprises in addition a water soluble carboxylalkyl starch or carboxyalkyl cellulose at from 0.1 to 20 percent by weight based on weight of the intermediate layer (dry weight basis).

The transfer layer is non-separable meaning that during use of the ink jet receiving sheet for indirect printing onto a textile or tile or other surface, the transfer layer does not separate from the intermediate layer or from the substrate. The sublimable dyes under hear or pressure transfer from the transfer layer to the target surface but the layers of the ink jet receiving sheet do not separate or peel to the target surface.

The transfer layer is from 0.1 to 6.0 gsm.

The intermediate layer comprises from 10 to 60 weight percent of an oil absorptive pigment having an absorbance of at least 90 grams per square meter and in an alternate aspect at from 15 to 30 weight percent of an oil absorptive pigment. The intermediate layer is positioned between the transfer layer and the substrate sheet. The intermediate layer comprises in addition a carboxyalkyl starch or carboxyalkyl cellulose at from 0.1 to 20 percent by weight based on the weight of the intermediate layer (dry weight basis).

The intermediate layer can be substantially similar in composition to the composition of the transfer layer, even identical. However in one embodiment, it is important that the layers be separately applied layers. Surprisingly, the interface between the two layers gives rise to a dye particle holding effect which the interface seems to augment, while the water phase seems to more easily transit the interface boundary. However, applicant does not intend to be limited to any one theory or postulated mechanism about this effect.

In an alternative embodiment, the transfer layer and intermediate layer can be blended as one single layer.

The components of the respective layers, the transfer layer and the intermediate layer are substantially insoluble in the dispersion vehicle (preferably water) and are ground to an individual average particle size of between about 1 micron to about 10 microns, preferably about 1-3 microns or less. The binder material is substantially vehicle soluble although latexes are also eligible in some instances. The binder material is selected from carboxyalkyl starch or carboxyalkyl cellulose.

Coating weights of the respective, transfer layer and intermediate layer, can each be independently selected from about 0.1 to about 6 grams per square meter (gsm) and preferably about 1 to about 3.5 gsm. The combined coat weight of the two layers is from about 0.75 to 6 gsm, more preferably from 1 to 4.5 gsm.

### EXAMPLES

Formula 1

| Parts | |
|---|---|
| 13 | polyvinylalcohol (celluol, Celanese Corp, Dallas, Texas) at |
| | 20% solids |
| 1.25 | surfactant (Surfynol CT 111, Air Products, Allentown, |
| | Pennsylvania) [poly (oxy-1,2-ethanediyl, a-(monylphenyl)-w- |
| | hydroxy-branched tetramethyl-5-decyne-4,7-diol, 2,4,7,9] |
| | Surfynol D101 (1:4 blend of surfactants) |
| 57.5 | aluminum silicate Ansilex (45% solids) |
| 23.25 | calcium carbonate (74% solids) |
| 5 | carboxymethyl cellulose |

Formula 2

| Parts | |
|---|---|
| 13 | polyvinylalcohol (celluol, Celanese Corp, Dallas, Texas) at |
| | 20% solids |
| 1.25 | surfactant (Surfynol CT 111, Air Products, Allentown, |
| | Pennsylvania) [poly (oxy-1,2-ethanediyl, a-(monylphenyl)-w- |
| | hydroxy-branched tetramethyl-5-decyne-4,7-diol, 2,4,7,9] |
| | Surfynol D101 (1:4 blend of surfactants) |
| 57.5 | aluminum silicate Ansilex (45% solids) |
| 23.25 | calcium carbonate (74% solids) |
| 5 | carboxymethyl cellulose |

### Example 1

Transfer layer—Formula 1 (2 lb/ream) (0.9 kg/ream)

Intermediate layer—Formula 1 (4.5 lb/ream) (1.8 kg/ream)

(ream=3300 square feet)

Coatings of the double layers were applied onto a ream of paper substrate (62 lb basis weight). The intermediate layer was dried followed by coating of the transfer layer.

Dye Sublimation Comparison Dry Times after printing on Epson Stylus 4000 printer with Artanium inks (standard test pattern).

| | Dry Time |
|---|---|
| Example 1 | 2 min 29 sec |
| Coldenhove ™ HTR 4000 Comparative 1 | 23 min 17 sec |
| Chamtenaro Digijet ™ 1000 Comparative 2 | 13 min 8 sec |
| HTR ™ Coldenhove (Erbeek, Netherlands) | [Commercial Sample 1] |
| Digijet ™ Chantenero AG (Cham, Switzerland) | [Commercial Sample 2] |
| APN Kaocol | [Commercial Sample 3] |

### Example 2

Transfer layer—Formula 1

Intermediate layer—Formula 1

Comparative 3

Single layer—Formula 1

Dye Sublimation Dry Time

Example 2 2 min 30 secs

Comparative>4 min.

### Example 3

| | | | | | TAPPI | |
|---|---|---|---|---|---|---|
| | | | | | method | |
| | | TAPPI | | | APN | |
| | | Method | | | method | TAPPI |
| | APN | T459 om- | APN | APN | T462 om- | method |
| | Method | 93 | Method | Method | 01 | T480 om- |
| | Croda Ink | Wax Pink | 1011.16 | 1011.16 | 10011.13D | 99 |
| | Ink | Tack of | IGT-5 ink | IGT-7 ink | Oil Absorb | Gloss-75 |
| Sample | Receptivity | Stick | IGT units | IGT units | Centimeters | Degrees |
| Coldenhove | 77.4 | 16.0 | 78.1 | 54.8 | 65.5 | 17.3 |
| (Erbeek, | | | | | | |
| Netherlands) | | | | | | |
| commercial | | | | | | |
| ink jet transfer | | | | | | |
| sheet | | | | | | |
| (average) | | | | | | |
| Cham-Tenero-1 | 78.7 | 16.0 | 84.3 | 63.5 | 65.0 | 16.9 |
| (Cham, | | | | | | |
| Germany) | | | | | | |
| commercial | | | | | | |
| ink jet transfer | | | | | | |
| sheet (average) | | | | | | |
| Example 1 | 43.9 | 2.0 | 39.0 | 39.1 | 39.0 | 2.7 |
| (average) | | | | | | |

Comparisons to commercially available ink jet transfer papers. Averages were results of two samples.

### Example 4

Density of paper before print

| | Example 1 | Commercial | Commercial | Commercial |
|---|---|---|---|---|
| | Sample | Sample 3 | Sample 2 | Sample 1 |
| Black | 1.26 | 1.21 | 1.22 | 1.22 |
| Cyan | 0.39 | 0.36 | 0.38 | 0.37 |
| Magenta | 0.99 | 1 | 1.02 | 1.12 |
| Yellow | 0.73 | 0.69 | 0.72 | 0.74 |

Density of paper after print

| | Example 1 | Commercial | Commercial | Commercial |
|---|---|---|---|---|
| | Sample | Sample 3 | Sample 2 | Sample 1 |
| Black | 0.92 | 0.93 | 0.97 | 0.94 |
| Cyan | 0.16 | 0.17 | 0.19 | 0.16 |
| Magenta | 0.66 | 0.72 | 0.76 | 0.74 |
| Yellow | 0.47 | 0.54 | 0.59 | 0.51 |

Density of fabric after transfer

| | Example 1 | Commercial | Commercial | Commercial |
|---|---|---|---|---|
| | Sample | Sample 3 | Sample 2 | Sample 1 |
| Black | 1.34 | 1.21 | 1.22 | 1.25 |
| Cyan | 0.85 | 0.8 | 0.82 | 0.84 |
| Magenta | 1.4 | 1.35 | 1.26 | 1.32 |
| Yellow | 0.87 | 0.8 | 0.75 | 0.8 |

Transfer Efficiency

| | Example 1 | Commercial | Commercial | Commercial |
|---|---|---|---|---|
| | Sample | Sample 3 | Sample 2 | Sample 1 |
| Black | 26.98 | 23.14 | 20.49 | 22.95 |
| Cyan | 58.97 | 52.78 | 50.00 | 56.76 |
| Magenta | 33.33 | 28.00 | 25.49 | 33.93 |
| Yellow | 35.62 | 21.74 | 18.06 | 31.08 |

### Example 5

| | % of dry solids |
|---|---|
| Polyvinyl alcohol | 15% |
| Surfynol CT-111 | 1% |
| Surfynol DT-101 | 1% |
| Ansilex clay | 57.75% |
| Syloid 74 × 5500 | 15.25% |
| Hydrocarb 90 PCC | 15.25% |
| Carboxymethyl starch | 5% |
| Water | Balance |

The above formulation was prepared for use as a coating layer useful as an intermediate layer or a transfer layer or both.

### Example 6

| | % of dry solids |
|---|---|
| Polyvinyl alcohol | 15% |
| Surfynol CT-111 | 1% |
| Surfynol DT-101 | 1% |
| Ansilex clay | 57.75% |
| Syloid 74 × 5500 | 5% |
| Hydrocarb 90 PCC | 15.25% |
| Carboxymethyl cellulose | 5% |
| Water | Balance |

The coatings from Examples 5 and 6 were applied to 62 pound basestock at 8 pounds per 300 ft². The coated sheets were printed on an Epson 4000 printer using Artanium dye sublimation inks and allowed to dry. The printed sheets were transferred to polyester coated fiberglass panels using a heat press at 400° F. for 75 seconds. Transferred densities of color bars was measured using a densitometer. Higher numbers are darker, more intense images.

Transferred Densities

Ink Color

| | Cyan | Magenta | Yellow | Black |
|---|---|---|---|---|
| Example 6 | 0.94 | 1.69 | 0.79 | 2.56 |
| Example 5 | 0.88 | 1.69 | 0.82 | 2.44 |

### Example 7

The data in the table below indicates that at 25% CMC in the coating the transferred image density decreases. This is evident by the lower transferred densities and the higher ink densities remaining in the sheet.

The other observation made during printing was the rate at which ink was absorbed into the sheet. As the CMC level increased the ink absorption rate decreased. Above 10-15% CMC level the absorptive rate was slow.

| | | % CMC | | | | | | |
|---|---|---|---|---|---|---|---|---|
| | | 0% | 3% | 5% | 10% | 15% | 20% | 25% |
| Sheffield Porosity (units) | | 41.9 | 35.0 | 32.0 | 25.6 | 21.3 | 16.5 | 9.8 |
| Sheffield Smoothness (units) | | 105.6 | 113.8 | 125.6 | 126.9 | 135.6 | 167.5 | 177.5 |
| Density (Transferred to polyester) | Cyan | 1.00 | 1.04 | 1.06 | 1.03 | 1.04 | 1.05 | 0.97 |
| Density (Transferred to polyester) | Magenta | 1.90 | 1.92 | 1.89 | 1.86 | 1.91 | 1.93 | 1.82 |
| Density (Transferred to polyester) | Yellow | 0.73 | 0.73 | 0.70 | 0.69 | 0.72 | 0.73 | 0.69 |
| Density (Transferred to polyester) | Black | 2.86 | 3.03 | 2.80 | 2.96 | 2.77 | 3.04 | 2.58 |
| Density (Coated sheet after transfer) | Cyan | 0.20 | 0.18 | 0.18 | 0.18 | 0.18 | 0.2 | 0.27 |
| Density (Coated sheet after transfer) | Magenta | 0.46 | 0.38 | 0.37 | 0.35 | 0.38 | 0.42 | 0.58 |
| Density (Coated sheet after transfer) | Yellow | 0.20 | 0.18 | 0.18 | 0.17 | 0.18 | 0.2 | 0.24 |
| Density (Coated sheet after transfer) | Black | 0.50 | 0.47 | 0.45 | 0.46 | 0.53 | 0.57 | 0.7 |

Samples were prepared using substantially the formulation of Example 6 but varying the carboxymethyl cellulose dry solids percent at 0%, 3%, 5%, 10%, 15%, 20% and 25% as indicated in the table.

What is claimed is:

1. A thermal transfer image receiving sheet comprising:
a substrate sheet having a first surface and second surface;
a non-separable transfer layer provided on at least a first surface of the substrate;
an intermediate layer coated between the transfer layer and paper substrate;
wherein the non-separable transfer layer and intermediate layer are relatively permanently affixed to the substrate;
wherein the intermediate layer comprises an oil absorptive pigment having an absorbance of at least 90 grams per square meter, and a binder composition comprising a water soluble carboxyalkyl starch or cellulose at from 0.1 to 25 percent by weight based on weight of the intermediate layer;
wherein the transfer layer comprises an oil absorptive pigment having an absorbance of at least 90 grams per square meter, and a binder composition comprising water soluble carboxyalkyl starch or carboxyalkyl cellulose at from 0.1 to 20 percent by weight based on weight of the transfer layer.

2. The thermal transfer image receiving sheet according to claim 1 wherein the receiving sheet has a surface drying time of less than 5 minutes at 28° C. and 55% relative humidity.

3. The thermal transfer image receiving sheet according to claim 1 wherein the intermediate layer coat weight is at least 3 grams per square meter.

4. The thermal transfer image receiving sheet according to claim 1 wherein the substrate comprises a cellulose-based material and is useful as a transfer paper.

5. The transfer paper according to claim 1 wherein the carboxyalkyl starch or cellulose is carboxymethyl starch or carboxymethyl cellulose.

6. A transfer paper useful as a thermal transfer image receiving sheet comprising:
a substrate sheet having a first surface and second surface;
one or more layers comprising a non-separable transfer layer provided on at least a first surface of the substrate; and
an optional intermediate layer coated between the transfer layer and paper substrate; wherein the non-separable transfer layer and intermediate layer are relatively permanently affixed to the substrate;
wherein the intermediate layer comprises from 3 to 70 weight percent of an oil absorptive pigment having an absorbance of at least 90 grams per square meter, and a binder composition comprising a water soluble carboxyalkyl starch or cellulose at from 0.1 to 20 percent by weight based on weight of the intermediate layer;
wherein the transfer layer comprises from 3 to 70 weight percent of an oil absorptive pigment having an absorbance of at least 90 grams per square meter, and a binder composition comprising water soluble carboxyalkyl starch or cellulose at from 0.1 to 20 percent by weight based on weight of the transfer layer;
wherein the receiving sheet surface drying time is less than 4 min at 28° C. and 55% relative humidity.

7. The transfer paper according to claim 6 wherein the intermediate layer has a coat weight is at least 3 grams per square meter.

8. The transfer paper according to claim 6 wherein the substrate comprises a cellulose-based material.

9. The transfer paper according to claim 6 wherein the carboxyalkyl starch or cellulose is carboxymethyl starch or carboxymethyl cellulose.

10. The transfer paper according to claim 6 wherein the substrate is paper.

11. A transfer paper useful as a thermal transfer image receiving sheet comprising:
a substrate sheet having a first surface and second surface;
a non-separable transfer layer provided on at least a first surface of the substrate and forming a new surface;
wherein the non-separable transfer layer is relatively permanently affixed to the substrate;
wherein the transfer layer comprises an oil absorptive pigment having an absorbance of at least 90 grams per square meter, and a binder composition comprising water soluble carboxyalkyl starch or carboxyalkyl cellulose at from 0.1 to 20 percent by weight based on weight of the transfer layer; wherein the new surface of the transfer image receiving sheet is fast drying.

12. The transfer paper according to claim 11 wherein the new surface drying time is less than 5 minutes at 28° C. and 55% relative humidity.

13. The transfer paper according to claim 11 wherein the intermediate layer has a coat weight is at least 3 grams per square meter.

14. The transfer paper according to claim 11 wherein the substrate comprises a cellulose-based material.

15. The transfer paper according to claim 11 wherein the carboxyalkyl starch or cellulose is carboxymethyl starch or carboxymethyl cellulose.

16. The transfer paper according to claim 11 wherein the substrate is paper.
